(19) United States
(12) Patent Application Publication
(10) Pub. No.: US 2020/0008447 A1
(43) Pub. Date: Jan. 9, 2020

(54) USE OF A FEED SUPPLEMENT FOR RUMINANTS

(71) Applicant: Graeme Douglas COLES, Coalgate (NZ)

(72) Inventor: Graeme Douglas COLES, Coalgate (NZ)

(21) Appl. No.: 16/574,255

(22) Filed: Sep. 18, 2019

Related U.S. Application Data
(63) Continuation-in-part of application No. 14/888,092, filed on Oct. 30, 2015, now abandoned.

(51) Int. Cl. A23K 20/20; A23K 10/37; A23K 50/10; A23K 20/105; A23K 20/24; A23K 10/12; A23K 10/18

(52) U.S. Cl. CPC A23K 20/30; A23K 10/37; A23K 50/10; A23K 10/18; A23K 20/24; A23K 10/12; A23K 20/105

(57) ABSTRACT

The use of a feed supplement to improve the feed utilisation of a ruminant where said feed supplement is prepared by reacting a prepared precursor, which contains organic acids, with a multivalent cation source to precipitate a reaction product, where:—the prepared precursor is prepared from a plant precursor selected from the group consisting of an undried fermentation by-product, an undried fermentation product, undried acidic plant material and an undried pomace; and—the prepared precursor contains C3/C4 organic acids.

### TECHNICAL FIELD

The present invention relates to a method for improving one or more specified characteristics of ruminant animals by feeding to the animals a prebiotic dietary supplement prepared as discussed below.

### BACKGROUND ART

Any discussion of the prior art throughout the specification is not an admission that such prior art is widely known or forms part of the common general knowledge in that field.

It is well known to feed ruminant animals various dietary supplements to remedy specific dietary deficiencies e.g. mineral supplements to overcome copper, magnesium or selenium deficiencies. The supplements may be given as an addition to the diet for such period as is required to overcome the deficiency, or on a regular basis. The supplements may be given separately e.g. as a lick block or as a drench, or may be mixed into a feed preparation.

It also is known to treat various waste products from manufacturing processes such as fermentation byproducts for use as a regular animal feed e.g. for animals confined indoors or for animals where their normal grazing is not sufficient to meet their normal dietary requirements.

### DISCLOSURE OF INVENTION

An object of the present invention is the provision of a method of supplementing the diet of a ruminant animal which not only remedies dietary deficiencies, but which also has overall metabolic advantages.

The present invention provides a method of supplementing the diet of a ruminant animal to improve one or more of the features selected from the group consisting of:
ruminal efficiency;
elevation of rumen pH and depression of faecal pH;
weight gain;
feed utilisation;
utilisation of dietary protein;
reduction in nitrogen excretion;
immune function;

wherein for a period of at least 10 days the animal is fed a prebiotic supplement in a quantity equivalent to at least 2% of the total daily dry matter intake for that animal; and wherein the supplement includes at least one chelate of a C₃/C₄ organic acid, microbial components and non-starch polysaccharides;

and wherein the supplement is prepared by reacting a prepared precursor which contains C₃/C₄ organic acids with at least one multivalent cation source to precipitate one or more reaction products;

and wherein the prepared precursor is prepared from a starting material selected from the group consisting of:
an un-dried fermentation or distillation byproduct;
an un-dried fermentation or distillation product;
un-dried acidic plant material;
un-dried pomace;
whey.

It has been theorised that the combination of a chelate of a C₃/C₄ organic acid, microbial components, and non-starch polysaccharides has a synergistic effect i.e. the combination has a much greater effect in producing the desired results in animals being fed the supplement, than would be achievable by any of the individual components.

Preferably, the C₃/C₄ organic acid is a lactic acid.

If the starting material is whey, then the microbial components will be those typically found in different wheys e.g Lactobacillus or Bifidobacter species. For the remainder of the list of starting materials, the predominant microbial component will be yeasts.

The supplement used in the method of the present invention originally was developed to stabilise and preserve wine making waste, then latterly simply to provide specific mineral supplements in a highly palatable form. However, when experiments were undertaken to test the suitability of the supplement, the experimental results showed unexpected and unanticipated benefits which went far beyond simply remedying a mineral deficiency in the diet.

From those early experiments, the composition of the supplement was refined and the method of using the supplement was developed to maximise the advantages to the animals receiving the supplement.

Further experiments, as described herein, have demonstrated that the method of the present invention is capable of providing ruminant animals with one or more significant benefits.

As used herein, the terms set out below have the stated meanings:
‘Supplement-Mg’ means a supplement prepared by reacting any of the prepared precursors with a magnesium compound (such as MgO)
‘Supplement-Ca’ means a supplement prepared by reacting any of the prepared precursors with a calcium compound.
“prebiotic” means a formulation which includes a type of fibre which feeds the flora in the digestive system.
“Milk quality” refers to the criteria for assessing milk quality as set out by the New Zealand dairy industry i.e. the sum of the % content of milk protein and milk fat. The higher this figure, the better the quality of the milk i.e. the higher its nutritional quality. The expected levels of milk protein and milk fat vary according to the season of the year and the type of feed the animal is consuming. There are also significant differences between different breeds of cattle:—typically, high quality Fresian milk will have a milk quality figure in the range 7% to 8%, but a high quality Jersey milk would have a figure in the range of 8% to 9.5%.
“Body condition scoring” refers to the criteria for assessing the condition of cattle as set out in the Dairy NZ Body Condition Scoring Guide (WWW.dairynz.co.nz/animal/body-condition-scoring/)

Body condition scoring sets out the criteria to determine the condition of cattle and is used to ensure (for example) that cattle are in sufficiently good condition to be mated and/or to calve. Typical target body condition scores are:—
Mature cow—body condition score 5
Heifer and rising 3-year-old—body condition score 5.5
All animals in a herd must score above 3:—urgent action needs to be taken if any animal in the herd falls below a body condition score of 3. The Dairy NZ guide gives full instructions as to how to conduct a body condition score on cattle. It should be noted that body condition scoring allows for the estimation of the level of muscling and fat cover on cattle, independent of the animal's skeletal structure.
“C₃/C₄ acids” refers to organic acids which contain three or four carbon atoms.
“Feed utilisation” refers to the proportion of feed fed to an animal which can be utilised by that animal.
“Multivalent cation” refers to a cation with a charge of at least +2.
‘kPU’ stands for ‘Knewe (T.M) prebiotic unit’ and is the quantity of supplement needed to deliver 8 g of magnesium chelated with lactic acid, per day.

### BRIEF DESCRIPTION OF DRAWINGS

By way of example only, preferred embodiments of the present invention are described in detail, with reference to the accompanying drawings, in which:—

FIG. 1 is a flowchart showing, in generalised form, the route for preparing the supplement used in the method of the present invention;

FIG. 2 is a flowchart showing the route for preparing a preferred supplement for use in the method of the present invention;

FIG. 3 is a graph of milk yield v time from Example 1;

FIG. 4 is a graph of milk solids production from Example 2;

FIG. 5 is a graph of milk protein yield from Example 2;
FIG. 6 is a graph of milk urea secretion from Example 2; and
FIG. 7 is a graph showing a comparison of weight gain for 125 control fed and 125 experimentally fed dairy-beef cross pre-pubertal heifers from Example 4.

### BEST MODE FOR CARRYING OUT THE INVENTION

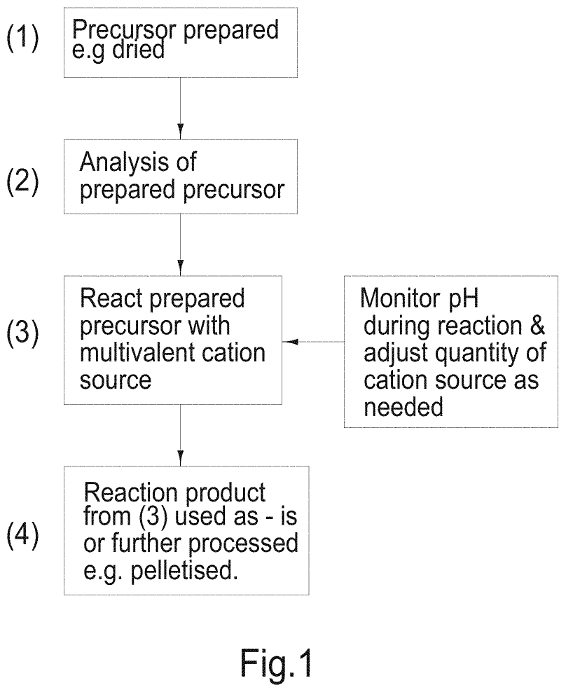

Referring to FIG. 1, stage I involves the initial preparation of the precursors. The precursors are selected from the group consisting of:
an un-dried fermentation or distillation byproduct;
an un-dried fermentation or distillation product;
un-dried acidic plant material;
un-dried pomace;
whey.

In general, many of these products contain excess water, and this is removed by drying at as low a temperature as possible to concentrate the precursor. The reason for keeping the temperature at low as possible is to minimise the damage to proteins in the precursor.

The precursor can be any plant-based material that has organic acids present, or whey (which also contains organic acids). For example, the precursor may be: marc (the fruit skins and seeds after fermentation and pressing) from grape wine making, fruit pomaces, fermentation or distillation products or byproducts, including those from milk, rice, potato, grain or fruit fermentation processes such as wet distillers grains (VVDG), condensed distillers solubles (CDS), thin stillage and wheys.

Typically, fermentation byproducts are produced from industry ferments using Saccharomyces cerevisiae (brewers' yeast) or selected bacteria (e.g. Lactobacillus ssp) to produce an industrially desirable product (e.g. ethanol, cheese) which is separated from the ferment by filtration or distillation.

Marc consists of grape skins, seeds and stems, all moistened by the residual wine which cannot be removed by pressing. This wine includes alcohol and also a mixture of three and four carbon organic acids, glycerol, and yeast components. Alcohol is readily oxidised to acetic acid, and the organic acid mixture is converted to lactic acid and/or propionic acid after pressing.

Pomace from white wine production is produced prior to fermentation to wine. It contains substantial quantities of organic acids (e.g. malic acid, tartaric acid,) it also contains significant amounts of simple fruit sugars. These sugars may be fermented to produce organic acids, preferably lactic acid, using known combinations of yeasts and bacteria. Other fruit pomaces may also be treated in this way.

The precursor must contain C₃/C₄ organic acids, microbial components, and non-starch polysaccharides.

If the precursor is a pomace, it is advantageous (but not essential) to ferment the pomace before reacting with a multivalent cation source.

Preferably, the precursor also contains C₃-C₆ sugars and polymers of these (including glycerol and esters) and/or protein with a high protein efficiency ratio. A high protein efficiency ratio is defined as applying to a protein complement with a high content of essential amino-acids relative to whole egg protein.

Preferably also, the precursor contains 20 to 30% organic acids, of which no more than 10% of total acids present is acetic acid, and the balance is high in lactic acid or other C₃/C₄ acids.

Preferably, if the precursor is an acidic plant material, the plant material has a pH of below about five e.g. lemon juice, peaches, plums, taro, tomatoes, apples and apricots.

Preferably also, the precursor contains 5 to 15% glycerol, 5 to 50% protein and 5 to 50% non-starch polysaccharides; preferably the majority of the non-starch polysaccharides are arabinoxylans and/or beta-glucans of cereal origin, pectins of plant cell wall origin and/or yeast cell wall components.

As part of the necessary preparation, the precursor may be subject to one or more of the following processes:
additional fermentation;
blending of various different precursors;
the addition of processing aids.

In stage 2, the prepared precursor is analysed to determine the organic acid concentration and the water content, and these levels are adjusted to predetermined levels as necessary.

In stage 3, the prepared precursor is reacted with a multivalent cation source. The multivalent cation source may be any of a wide range of metallic compounds (or mixtures of metallic compounds), providing that the metals are non-toxic at the levels used. Typical multivalent cation sources include compounds of magnesium, calcium, iron, copper, cobalt, manganese, zinc and molybdenum.

For example, the multivalent cation source can be a natural mineral such as limestone, dolomite, or magnesite or could be one or more oxides, carbonates, hydroxides, chlorides, sulphates, nitrates or phosphates of one or more multivalent cations of natural or artificial origin. If natural minerals are used, the minerals need to be of sufficiently high quality to minimise any contamination of the final product, and the physical properties of the cation source must be such that they allow reactions to occur in an acceptable time.

In the stage 3 reaction, the multivalent cation source reacts with at least some of the organic acids in the prepared precursor, and possibly also with one or more of the following constituents of the prepared precursor:
terminal carboxyl residues of protein;
acidic amino acids;
carboxyl and other acid residues within the carbohydrate fraction;
other acidic residues.

The stage 3 reaction may involve chelating some of the organic acids, neutralising some of the acidic species, and/or forming salts, chelates or complexes.

Preferably, the pH of the reaction product is measured at intervals during the stage 3 reaction, and the quantity of multivalent cation source is adjusted as necessary to obtain a target pH; the target pH preferably is in the range 6.3-7.2, more preferably 6.9-7.2.

In stage 4, the reaction product from stage 3 may be used directly as a dietary supplement:—depending upon the precursor used, it may be in a physical form suitable for direct use. However, if necessary, the reaction product from stage 3 is further processed to improve its handling qualities e.g. powdered or pelletised. In addition, further additives (e.g. minerals, vitamins, antibiotics) can be added if required.

In many cases, the reaction product from stage 3 requires drying. This is done at as low a temperature as possible, to avoid degrading the product. The drying may be carried out by any of a range of techniques e.g. spray drying, oven drying, microwave drying, infrared drying, radio-frequency drying, and can be carried out under normal pressure or under reduced pressure.

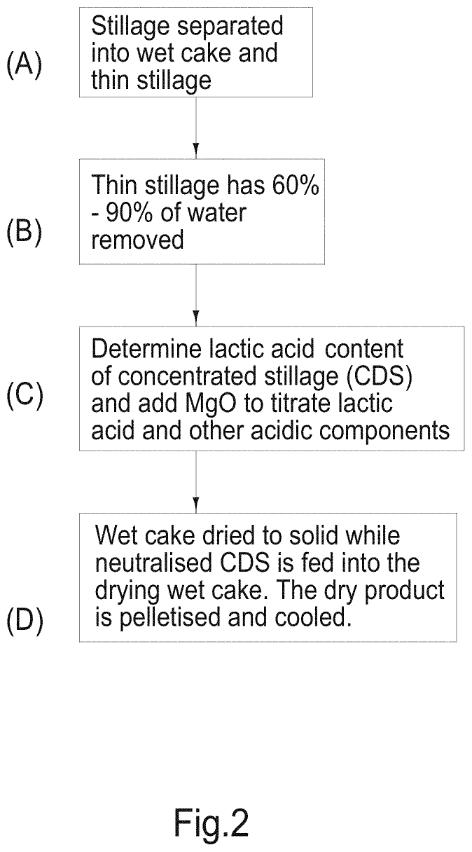

FIG. 2 shows a flowchart of a preferred magnesium rich supplement (referred to hereinafter as “Supplement—Mg”).

Supplement-Mg may be prepared from any of the listed precursors. In the following example Supplement—Mg uses a distillation byproduct termed “stillage” as a precursor. Stillage is the material which remains when the distillation has reached its desired end point, and a maximum amount of ethanol has been removed. Thus, stillage includes all of the non-fermentable components of the original raw material, as modified by the physical and chemical/biochemical processes to which they are subject during fermentation and distillation. Stillage includes yeast stress products (principally lactic acid and glycerol) and the yeast components which are produced during fermentation. It is known to use stillage directly as a livestock feed, but it is very susceptible to microbial degradation, and also has a relatively high moisture content which makes it expensive to transport.

In stage A of the process of the present invention, the stillage first is physically separated using a form of centrifuge, to separate a majority of the insoluble solids (known as “wet cake”) from the fraction containing solubles and lower density components (known as “thin stillage”).

The thin stillage contains much of the most nutritious material from the original stillage (including the protein of the highest biological value) but may be only 4 percent—10 percent dry matter. In stage B, between 60 percent and 90 percent of the water is removed from the thin stillage, e.g. by vacuum evaporation. The resulting product has a dry matter content of between 32 percent and 40 percent, and is known as “condensed distillers' solubles” (CDS). It is not possible to dry the CDS to a powder, because it has a relatively high content of glycerol and lactic acid.

Conventionally, to stabilise the CDS against microbial degradation and to render it into a suitable form for transport, storage and remote feeding, it is necessary to dry the C DS onto a suitable substrate.

In stage C the lactic acid content of the stillage is determined and is standardised to 20 percent using additional food grade lactic acid if necessary. The amount of 99 percent magnesium oxide (MgO) required to titrate the total lactic acid present is calculated and added to the CDS, with the CDS at a temperature of about 75° C. Following this, the pH of the material is determined, and the quantity of MgO required to titrate the other acidic components present (which include proteins, pectins, and organic acids other than lactic acid) is calculated. This further quantity of MgO is mixed into the standardised CDS.

In stage D, the neutralised CDS from stage C is fed on to a continuous flow of wet cake as the wet cake is dried in a drum drier or other suitable drier, and the dry product is (optionally) pelletised, then cooled and packed for transport. The product is now ready to be used as a feed supplement.

In stage D, the reaction product is dried at a relatively low temperature to form a product which may be used directly as a supplement or may be further processed e.g. by pelletisation.

The drying temperature selected depends upon the type of drier being used. For example, if a drum drier is used, the drying temperature is approximately 110° C. However, if a cyclone drying mill is used, the drying temperature may be as low as 80° C.

The product may also be dried by freeze drying or by spray drying. A typical spray drying temperature is about 170° C.

It has been found that the product of the present invention dries more rapidly and at a lower average temperature than unreacted CDS. The product of the present invention also dries to a stable powdered form which is highly suitable for further processing.

It should be noted that the drying at stage D has two functions:—it removes water from the reaction mixture and it also effectively “cooks” the material i.e. it involves processes which result in a reduction of the chemical activity of the various reactive species in the reaction mixture. Essentially, because the thin stillage has been reacted with a multivalent cation source (in this case MgO) at stage C, the amount of energy required to stabilise the reaction mixture components overall is reduced because at least one of those mixture components has been chemically changed.

Preferably, the drying temperature is below the temperature at which the Maillard reaction occurs (also known as the “Maillard Threshold Temperature”).

The lower drying temperature and the flocculation of the acidic, highly nutritional protein with magnesium cross links in combination maintain a significantly higher protein nutritional value after drying. The lower drying temperature also protects the yeast components and the soluble non-starch polysaccharides.

Usually when thin stillage is dried, the protein present is degraded and any non-starch polysaccharides present are converted to a form generally referred to as “hornified” i.e. hardened into a form which makes it difficult for an animal to digest the product. However, the reaction between the precursor products and the multivalent cation source (in this case the magnesium compound) chelates the organic acids present in the precursor; this enables the drying temperature to be reduced by at least 20° C. and the drying time also reduced, thus minimising the damage to the proteins contained in the precursor.

In addition, it is believed that the precipitation of the C₃/C₄ acids means that the biological activity of the acid species is preserved through the final drying of the product. Thus, the above described method of production facilitates the stabilisation of nutritionally important constituents by producing the solubility of the organic acids present, protecting the protein present, and protecting the bioactivity of the non-starch polysaccharides.

In the above examples, references been made to a single multivalent cation source, but it will be appreciated that several multivalent cation sources can be used together e.g. a mixture containing magnesium, calcium and manganese compounds.

The method of the present invention has the aim of supplementing the diet of a ruminant animal to improve one or more of the following features:
ruminal efficiency;
elevation of rumen pH and depression of faecal pH;
weight gain;
feed utilisation;
utilisation of dietary protein;
reduction in nitrogen excretion;
immune function.

To date, most of the experimental work has been carried out on cattle, but it will be appreciated that ruminant digestive systems tend to be similar overall, and it is therefore reasonable to propose that similar results will be obtained for any ruminant.

This is confirmed by a preliminary trial carried out by a herd of weaner deer (Cervus elaphus) hinds at weaning. The product was found to be highly palatable and the animals were calmer and easier to handle. Compared to a similar herd from the previous year, the animals were found to be thriftier, with a better retention of good body condition at the end of winter, and with better quality coats. In addition although deer are prone to a late winter reduction in appetite, this tendency was very much reduced in the test herd.

The supplement provided by the method of the present invention is a prebiotic i.e. it includes a type of fibre which feeds the flora in the digestive system of the animal, with the objective of enabling those flora to act more efficiently. This in turn leads to a more efficient digestion by the animal, which in turn improves feed utilisation i.e. more of the feed fed to the animal is properly broken down in the digestive process and turned into nutritionally useful products for the animal.

It is theorised that the lower temperature drying of the product, plus the formation of chelates and flocculated protein, contribute to the enhanced prebiotic effect of the supplement of the present invention, with a substantially greater effect than that obtained from any of the precursor materials alone, or the sum of such effects.

As part of the more efficient digestion by the animal, rumen pH is elevated (leading to a lower risk of rumen acidosis) and faecal pH is reduced (indicating an increased rate of hindgut fermentation and better colon health).

Assuming that the animal continues to be fed the same quantity of feed, it follows that a more efficient digestion of that feed leads to an increased weight gain. However, it has been found that the method of the present invention leads to the protein in the diet being utilised more efficiently, with the result that the protein levels of the diet fed to the animal can be reduced by 15-20%, without actually reducing the amount of protein taken up by the animal. This has a further benefit in that reduction in the protein level of the diet fed to the animal leads to a reduction of up to 50% in nitrogen excretion and thus a reduction in pollution. There is also a cost saving in that a lower protein feed can be used, without any disadvantages to the animals being fed.

It is theorised that the Supplement-Mg of the present invention, by providing a magnesium lactate chelate, in combination with the other constituents, stimulates the rumen flora; this results in an increase in the release of protein from forage and since much of this protein also contains magnesium and other minerals, the mineral requirements of that animal are better provided for by the forage.

It has also been found that the method of the present invention results in an improvement in the immune function of the animal, as evidenced by a significant reduction in the incidence of mastitis in dairy herds. Given that mastitis is caused by any one of a number of infectious organisms, a reduction in the incidence of mastitis can reasonably be assumed to indicate an improvement in the immune function of the animal.

The method of the present invention also reduces the incidence of calving problems such as metritis.

It must be emphasised that the advantages discussed above are not advantages which could reasonably have been expected from feeding any of the precursor materials plus a mineral supplement:—the precursor materials have been widely used as animal feeds, with or without a magnesium or other mineral supplement, and none of the advantages of the present invention have been obtained.

Below are given a number of experimental results from trials of the method of the present invention. All of the recorded trials were carried out for at least several weeks; it is believed that, since the supplement used in the method of the present invention is a prebiotic, the minimum feeding period to obtain benefit from the invention would be 10 days. However, there is no maximum period:—there are no known disadvantages of adopting the feeding regime the subject of the present invention indefinitely, apart from the cost of supplying the supplement. Realistically, many commercial herds would find it advantageous to feed a supplement in accordance with the method of the present invention year round to young/growing stock and first and second calvers, and overwinter/during drought periods, for older stock.

In all of the experiments the quantity of supplement fed is 2% to 5% of the total daily dry matter intake for the animal.

To calculate the quantity of supplement fed the amount of supplement is based on the relative metabolic mass of the animal receiving the supplement. This is calculated by raising the relative body weight to the power of 0.6 and then adjusting the weight of supplement fed by the derived ratio.

For example, assuming that the average metabolic mass is 500 kg for an adult dairy animal and the supplement is to be fed to a 330 kg beef heifer, the calculation is as follows:

$$\begin{matrix}Daily dose = kPU * {( 330 / 500 )}^{0.5} \\ = 360 * 0.78 \\ = 280 g\end{matrix}$$

### EXAMPLE 1

Supplement-Mg

Condensed distillers' solubles (CDS) syrup was collected from normal production from the facilities of Shoalhaven Starches Pty Ltd at Nowra, New South Wales, Australia, and transferred to the premises of Halcyon Products Pty Ltd in Melbourne, Victoria. This CDS is wheat-based. Under normal conditions, CDS from this source contains approximately 25% lactic acid (dmb—dry matter basis), but this shipment was somewhat depleted in this material, so was supplemented with technical grade lactic acid (All Raw Materials Pty Ltd, Young, NSW).

The CDS was heated to 55° C., and reacted with commercial feed grade magnesium oxide (Causmag International Pty Ltd, Melbourne, Victoria) with continuous stirring and monitoring of pH. When pH reached 7, addition of magnesium oxide ceased, and the product was prepared for drying. Small-scale spray drying studies had revealed the need to incorporate a quantity of maltodextrin to improve flow properties, so 10% additional maltodextrin was mixed with the slaked CDS.

The resulting mixture was spray dried using conventional techniques, and packaged for storage and transport in 20 kg quantities in moisture-proof plastic bags in cartons. Its composition is given in table 1. (Dairy One, Inc, Ithaca, N.Y., USA)

TABLE 1
Proximate composition of Supplement-Mg (LMg)

| Component | Content as fed |
|---|---|
| Moisture (%) | 10.5 |
| Dry matter (%) | 89.5 |
| Crude protein (%) | 16.7 |
| Available protein (%) | 13.6 |
| ADICP (%) | 3.0 |
| Adjusted crude protein (%) | 14.5 |
| Acid detergent fibre (%) | 1.8 |
| Neutral detergent fibre (%) | 4.2 |
| Non-fibre carbohydrate (%) | 58.2 |
| Starch (%) | 0.5 |
| Water-soluble carbohydrates (%) | 20.1 |
| Crude fat (%) | 1.9 |
| Ash (%) | 9.44 |
| Total digestible nutrients (%) | 68.0 |
| NE_{L} (Mcal/kg) | 1.57 |
| NE_{M} (Mcal/kg) | 1.62 |
| NE_{G} (Mcal/kg) | 1.06 |
| Calcium (%) | 0.11 |
| Phosphorus (%) | 0.55 |
| Magnesium (%) | 2.82 |
| Potassium (%) | 0.93 |
| Sodium (%) | 0.782 |
| Iron (ppm) | 115.0 |
| Zinc (ppm) | 26.0 |
| Copper (ppm) | 6.0 |
| Manganese (ppm) | 57.0 |
| Molybdenum (ppm) | 1.3 |
| Sulphur (%) | 0.21 |
| Chloride ion (%) | 0.59 |
| pH | 8.6 |
| Diet cation-anion difference (mEq/100 g) | 31.0 |

Digestible energy was estimated by near-infrared reflectance spectroscopy to be 14.4 MJ/kg.

Experimental Diet

For the purposes of this experiment, it was estimated that magnesium availability from Supplement-Mg would be similar to availability of magnesium from magnesium chloride or sulphate, i.e. approximately 65%. Provision of 6.5 g of magnesium absorbed therefore required daily intake of sufficient Supplement-Mg to provide a total of 10 g of magnesium, and this quantity was available from 400 g of the spray dried product.

For convenience, the 400 g of Supplement-Mg was incorporated in 2 kg of diet, the balance consisting of 1600 g of ground locally-grown new season's winter wheat (12.2% protein dmb). This mixture was supplemented by the manufacturer (Seales Winslow Ltd, Tinwald, New Zealand) with 0.1% of the manufacturer's proprietary palatability enhancer.

Control Diet

The control diet consisted of 40 g of dairy nutritional grade magnesium oxide (Causmag International Pty Ltd, Melbourne, Victoria) in 2 kg of supplement. The supplement consisted of the same wheat as used in the experimental diet, augmented by sufficient soybean meal (46% protein dmb) (Viterra Ltd, Auckland, New Zealand) to compensate for the difference in the protein content between the wheat and the Supplement-Mg displaced from the experimental diet formulation. This diet was also supplemented with the same proprietary palatability enhancer.

Composition

Composition of the two supplements was determined by an independent laboratory (Nutrition Laboratory, Institute of Food, Nutrition and Human Health, Massey University, Palmerston North, New Zealand). Results are given in table 2.

TABLE 2
Supplement composition

| Analyte | Experimental | Control |
|---|---|---|
| Dry matter content (%) | 89.4 | 89.8 |
| Ash (%) | 3.1 | 3.9 |
| Protein (%) | 10.9 | 11.9 |
| Fat (%) | 1.8 | 1.6 |
| Crude fibre (%) | 2.2 | 2.4 |
| NDF (%) | 6.5 | 8.5 |
| ADF (%) | 1.2 | 1.6 |
| Calcium (g/100 g) | 0.070 | 0.100 |
| Magnesium (g/100 g) | 0.77 | 1.35 |
| ME (MJ/kg) | >13 | >13 |

Feeding

For practical reasons, it proved necessary to provide the required magnesium to the entire herd through the feeding facilities on the rotary milking platform. It was for this reason that considerably more of the control diet was fed, as it was supplied to all members of the milking herd not being fed the experimental diet. Feeding of supplements commenced five days after animals were allocated to experimental groups.

Pre-Parturition

Animals yet to calve were maintained in a herd separate from other animals on the farm. Each day this mob of cows was brought into the milking shed, and fed their daily ration of the diets to which they were allocated.

As each cow calved, she was admitted to a post-calving group as part of the main herd, and was supplemented according to the regimen described below.

Cows in Milk

From calving, cows were included in the main herd. This herd was milked twice a day, and each animal received supplementation according to the group in which it was included. This took the form of 1 kg of the appropriate diet at each milking, with the addition of 100 mL of molasses to further enhance acceptability. Animals suffering adverse events (e.g. mastitis or lameness) were separated from the main herd, coming into the parlour for milking after the main herd was finished. From the end of calving, the herd began to be fed undercover untethered, so these animals suffering adverse effects were fed the same basal diet in a different pen within the main barn.

Results and Discussion

The target of the experiment was to provide control and experimental diets which would lead to similar nutritional and performance outcomes.

Supplement Composition

Apart from magnesium content, the differences in composition between the experimental and control supplements were not significant, given that in both cases, the supplement provided less than 10% of total dry matter intake daily.

Body Condition

The original group of cows prior to allocation to experimental subgroups had a range of body condition scores, from several at 3.5 (significantly underweight: all cows at this score had been recently purchased) to 5 (ideal weight). Animals with an initial condition score below 4.0 were not included in the trial, and the high condition animals were observed prior to calving. As expected, calving induced a loss of condition of around about 0.5 condition score units (Sheppard, pers. comm.).

Subsequent estimations of mean body condition score showed no significant differences between groups. As expected, all animals rapidly recovered condition after calving, so that after one month of lactation, almost all animals comfortably fell into a condition score range of 4.5 to 5.0. Thus, it appears that the experimental diet caused no differences in body condition score, or the rate of recovery after calving.

Production Data

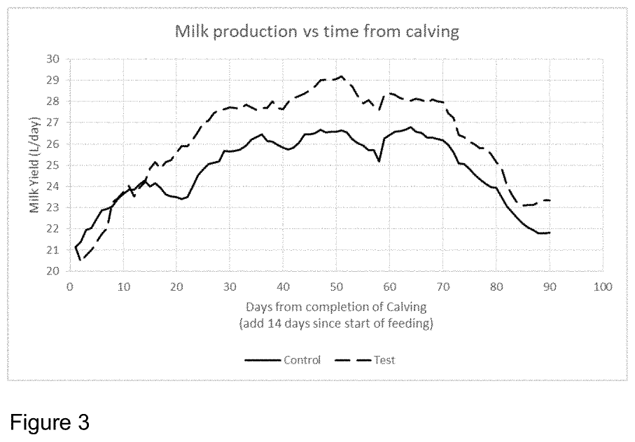

Milk production data in the form of 24 hour milk volume for each cow were collected daily. Conducting ANOVA using a General Linear Model to permit analysis of unbalanced data indicated a small but significant overall advantage in milk yield from cows on the experimental diet (25.01 L/day vs 24.21 L/day; p=0.001). However, there was a very significant interaction between diet and time (FIG. 3).

It seems possible that this interaction is due to a requirement for adaptation to one or more components of the experimental diet, but that once this adaptation is achieved, there is a sustained, significant advantage in milk yield. If the first four weeks of the trial (during which cows calved) are ignored, the interaction between diet and time disappears completely, as expected, and the advantage conveyed by the experimental diets increases (26.95 L/day vs 24.89 L/day, or 8%).

In this trial, the sampler cows were managed as a separate group. Despite the small number of animals included in this group, a similar difference between treatments remained highly significant (23.6 L/day vs 21.6 L/day (p=0.000), or 9%)

In this trial the milk quality information included a result that showed milk urea content showed a 10% difference between the control and experimental diet, indicating a similar improvement in nitrogen metabolism in the experimental diet fed animals.

### EXAMPLE 2

This trial was conducted in the same herd as example 1, except that it was carried out in the spring instead of the autumn, and the cows were fed pasture instead of conserved forage. The experimental supplement was Supplement-Mg, manufactured from wheat CDS and was reacted with MgO as in Example 1, but it was dried by mixing with 1.5 times the weight of mill-feed (bran and pollard produced by roller-milling) (dry solids basis), then using a commercial drum dryer. It was notable that the air-on temperature of the drum dryer could be reduced from 130° C. to 110° C. while maintaining throughput, with consequent reduction in the extent of over-cook.

The experimental diet consisted of 860 g of this supplement, combined with vitamins, minerals and a flavour enhancer. This provided 8 g of elemental Mg daily. The control diet consisted of the same combination of micronutrients but the experimental supplement was replaced by 40 g of feed-grade MgO (providing 22 g of elemental Mg) and 820 g of wheat wholemeal.

Three experimental treatments were provided, each to 150 adult cows randomly selected from 800 cows. The experimental and control treatments were fed 500 g/milking of the respective diets, and a third treatment was fed a 1:1 blend of the two diets at 250 g of each at each milking.

Supplementation was carried out for 16 weeks commencing from approximately 50 days after the mean calving date for the herd. Daily milk yield for each cow was determined. A subset of seven animals was chosen from each main treatment, and their milk composition determined at baseline and every 14 days thereafter. Comparison of the three sub-groups at baseline showed no differences in any milk composition parameter. Milk production was monitored for two months after feeding ceased. At the end of this period, a further collection of milk samples was made from the subgroups for milk composition determination.

Nearly three times as many cows were used in this trial as in trial 1, and once again, a small, but significant, increase in milk yield was obtained. This trial also showed a substantial increase in milk solid concentration, giving a 16% increase in milk solid yield. This result was quite unexpected. Surprisingly this increase persisted for two months after the feeding of the Supplement-Mg (LMg) had ceased.

Detailed analysis of the production results showed that Supplement-Mg had no effect on daily protein secretion, indicating that the herd husbandry was optimal for exploiting genetic potential for milk protein production. The entire increase in milk solids production was due to increased secretion of milk fat (Lactose secretion was also not statistically different between treatments).

For each milk composition sample, the relevant measure of daily milk yield and a three-day average centred on the sampling day were determined. Estimates of daily milk component yields were made based on both estimates of milk volume. Estimates of total milk solids yield using both milk volume estimates were compared. The precision of the statistical analysis of the samples based on the three-day mean volume yield was higher than on the single day, as expected, so all analyses reported below are based on three-day mean milk production estimates.

Milk Solids Analysis

As described, analysis of variance was conducted on milk solids daily yield. Table A shows the results.

TABLE A
Daily milk solids yield

| Treatment | Daily milk solids yield (kg) | Percent of control |
|---|---|---|
| Experimental | 2.43 | 116% |
| 50:50 | 2.17 | 103% |
| Control | 2.10 | 100% |
| Significance | 0.00 | |

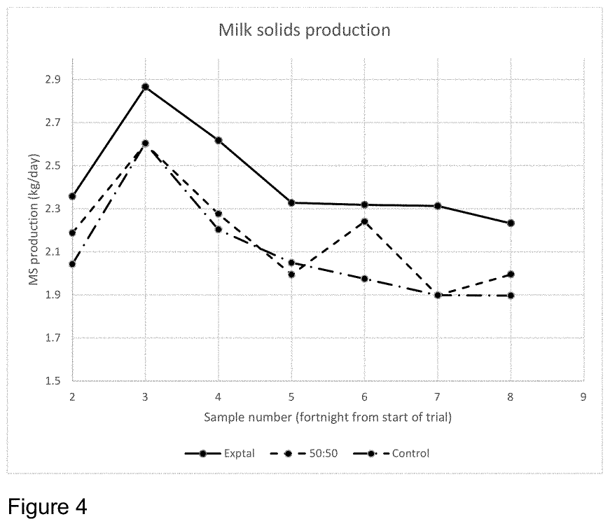

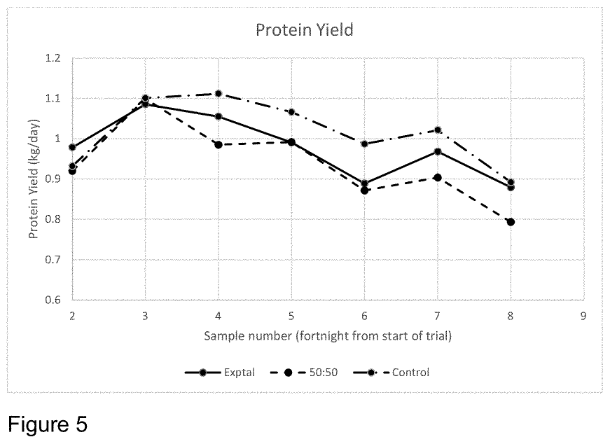

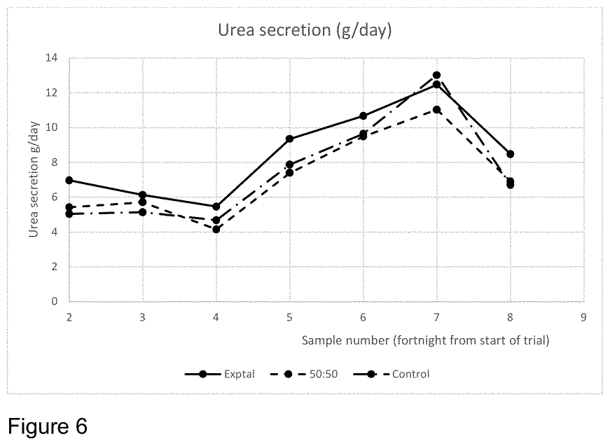

FIG. 4 shows the variation in daily milk solids yield during the course of the trial. The first points on the graph represent 2 weeks into the trial; subsequent points represent samples taken at further 2-weekly intervals.

The figure shows that the milk solids production advantage begins to be seen less than a fortnight after first feeding the product. Furthermore, it indicates that full advantage is only obtained from feeding the full recommended dose. There is no indication from these results that an advantage might be obtained from increasing the dose further: this requires further work.

Milk Fat Analysis

Prior milk fat percentage analysis indicated that it was this component that led to the major difference in milk solids production, so this parameter was investigated first. As expected, there was a major difference between the estimated total milk fat produced over the experimental period in the three treatments. (Table B)

TABLE B
Daily milk fat yield

| Treatment | Daily milk fat yield (kg) | Percent of control |
|---|---|---|
| Experimental | 1.46 | 136% |
| 50:50 | 1.22 | 114% |
| Control | 1.07 | 100% |
| Significance | 0.00 | |

Protein Yield

Mean milk protein percentage was lower in the experimentally-fed animals, but when the trial overall mean milk yields for the diets were used to estimate the trial milk protein yields, the daily values were very similar.

Analyses of data from the fortnightly milk composition figures and the related milk yield data gave similar results (Table C):

TABLE C
Daily milk protein yield

| Treatment | Daily milk protein yield (kg) | Percent of control |
|---|---|---|
| Experimental | 0.98 | 96% |
| 50:50 | 0.94 | 92% |
| Control | 1.02 | 100% |
| Significance | 0.003 | |

In this analysis, the 50:50 treatment was significantly lower that the control, but the experimental diet result was not different from the other treatments. FIG. 5 shows fortnightly results. The first points on the graph represent 2 weeks into the trial; subsequent points represent samples taken at further 2-weekly intervals.

These results indicate that there is a limit on the amount of protein the udder can secrete, although there does appear to be a slow decline at the end of the trial period. For this reason, an experiment being conducted in Scotland includes milking three times daily to see if the putative limit on secretion is caused by the udder reaching volume capacity, or if there is a physiological limit on the amount of protein that the udder tissue can synthesise.

Milk Urea Content

Milk urea content is highly correlated with serum urea concentration. Serum urea level, in turn, is the product of complex interchanges of nitrogen obtained from the diet and used for a number of purposes in the animal. These include:
Maintenance;
growth (including allocation of protein to muscle depots that act as protein stores);
reproduction, primarily through growth of a calf foetus and its associated membranes;
secretion, primarily of milk protein, but also enzymes and other proteins required for metabolism, mucins for lubricating the gut, naso-respiratory organs, genitals, et cetera, and;
metabolism.

Nitrogen is acquired from the diet in the form of peptides and/or individual amino acids, and these are used to provide the quantity of each essential amino acid the animal requires. In addition, amino acids may be interchanged to produce the balance of dispensable amino acids the animal requires as noted above, but metabolism takes the surplus of ingested amino acids, deaminates them (removes the amino group) and uses the remaining residue for energy production. The removed amino group may be used in the production of dispensable amino acids or mucins, but the surplus is converted to urea. In the healthy animal, urea is excreted to the environment via urine produced in the kidneys, and this excretory process serves to maintain the concentration of urea in the blood serum within a reasonably narrow range.

Clearly, the level of urea in milk is the outcome of a number of interchanges. However, provided one compares treatments where, apart from the treatment diet component, animals are treated similarly, the level of urea in milk is a useful indication of the availability of dietary protein. When evaluating a ruminant prebiotic, it is reasonable to assume that an increase in milk urea is due to an increase in the efficiency with which the rumen florae degrade protein-containing diet components, making the protein available either for direct absorption or conversion to microbial protein in the rumen, which is digested further along the gastrointestinal tract.

Daily milk urea secretion was compared between treatments (Table D)

TABLE D
Daily milk urea yield

| Treatment | Daily milk urea yield (g) | Percent of control |
|---|---|---|
| Experimental | 8.50 | 114% |
| 50:50 | 7.16 | 96% |
| Control | 7.44 | 100% |
| Significance | 0.001 | |

DairyNZ, in a popular publication (https://www.dairynz.co.nz/media/960934/feedright-milk-urea-info-sheet.pdf), indicates that expected milk urea concentration should lie in the range 20 to 40 mg/dL. It is noted that in the trial under discussion, some values significantly exceeded the upper limit of this range. This implies that the upper limit is not physiological, but a target for management that aids the farmer in careful use of expensive protein.

Other things being equal, this 14% increase in milk urea indicates a 14% increase in recovery of protein from forage. However, since maintenance, metabolic, and non-lactation secretion requirements are unlikely to vary markedly between treatments, and foetal growth is similarly unlikely to vary, the only confounding factor is likely to be variation in the level of allocation of protein to muscle depots for growth. It is unclear how the observed increase in body condition is achieved by differences in fat and muscle deposition. This requires further discussion.

FIG. 6 shows how milk urea yield varies with time and treatment. The first points on the graph represent 2 weeks into the trial; subsequent points represent samples taken at further 2-weekly intervals.

The experimental diet shows a consistent “advantage” over the other treatments with the exception of sampling time seven. Sample time seven occurred at a point when a significant drought had broken, leading to significant improvement in pasture quality. Otherwise, it is clear that daily milk urea secretion could be used as an indicator of enhanced forage degradation, and therefore acquisition of protein from the diet.

Milk urea excretion was 14% higher in the experimentally-fed group compared to the control, indicating a significant increase in dietary protein recovery. We deduce this because dietary crude protein provision was the same across all treatments, as was milk protein secretion, meaning that extra urea must have come from liver metabolism of excess digested amino acids.

The persistence of a production advantage after withdrawal of the experimental diet is believed to be due to the animals allocating more digested resources to body deposits during feeding than they were able to when consuming the control diet, then remobilising those extra resources to maintain elevated milk solids yield It was noted that animals consuming the third treatment achieved about 70% of the production increase achieved by the experimentally-fed animals, but that their partial production advantage disappeared shortly after supplement withdrawal.

It was also noted that during the trial, animals fed the experimental diet enjoyed a reduction in Log₁₀ SCC (somatic cell count). SCC is used as an indicator of inflammatory disorders and infections of the udder, and the lower the SCC level, the healthier the cow. The measured data were log-transformed to allow a valid statistical analysis, but when back-transformed, Supplement-Mg can be seen to have reduced SCC by approximately 60%.

### EXAMPLE 3

Peripubertal Feeding Trial of Beef Heifers

Supplement-Mg prepared as described in Example 1 was fed at 300 g/day (on a basal diet of fodder beet and baleage, to appetite), sufficient to provide 7.5 g of Mg daily, in the form of magnesium lactate to 25 peripubertal beef heifers. A control group of 25 similar animals was fed 260 g of wheat bran and 40 g of MgO on top of the same basal diet, the level of MgO being chosen to match the level of bioavailable Mg provided in the experimental diet.

Over a feeding period of 80 days, the experimentally-fed animals achieved 52 g/day greater weight gain than animals fed the control diet. At the commencement of the trial, the initial advantage in weigh gain was 217 g/day, but the onset of oestrus caused physiological changes in the animals in the trial, which commenced earlier in the animals on the experimental diet, as they reached the threshold weight and body condition necessary to initiate ovulation.

At the end of the trial, rumen liquor and faecal samples were collected approximately 90 minutes after animals were withdrawn from pasture. Animals fed the experimental diet had higher rumen liquor pH (7.30 vs 7.15, p=0.08) and lower faecal pH (7.34 vs 7.56, p=0.005) than control-fed animals. Both these differences are beneficial: elevated rumen pH is consistent with lower risk of rumen acidosis, while lower faecal pH is consistent with increased rate of hind gut fermentation, and better colon health.

Volatile fatty acids (VFA) and lactic acid level in both rumen liquor and faecal samples were determined and compared. No statistically significant differences for any VFA or lactic acid was found in faecal samples or rumen samples, but in the rumen samples, experimentally-fed animals had 16% lower total VFA plus lactic acid levels. This is consistent with more rapid clearing of fermentation products from the rumen, and consequent reduction in feedback inhibition. It is not clear how this effect is achieved, but it may be due to greater release of dibasic cations (e.g. Mg, Ca) from forage due to more extensive degradation of fibre, which chelate with acetate and propionate ions. These chelates are then cleared from the rumen in preference to ionised VFA residues.

### EXAMPLE 4

Prepubertal Heifer Feeding Trial

In a second trial, 250 prepubertal heifers were divided into two groups of 125. One group was fed a similar diet to that of Example 3 discussed above; the other group was fed a control diet as in Example 3. Weight gain was determined monthly and compared between treatments.

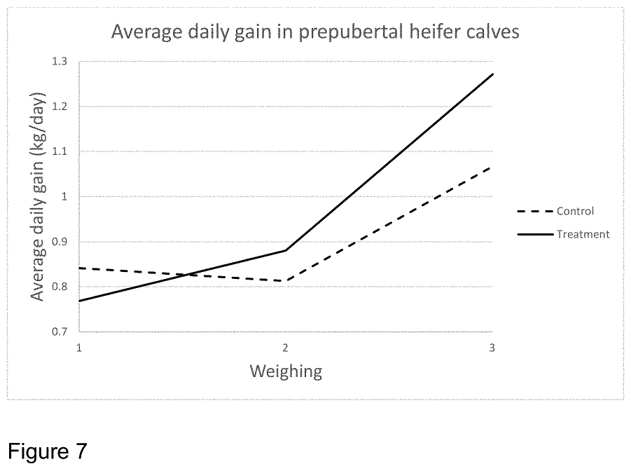

Animals were dairy-beef cross animals of similar origin, but at the commencement of the trial, control-fed animals were gaining weight faster than animals fed the experimental product as shown in FIG. 7, which gives a comparison of weight gain for control-fed (solid line) and experimentally-fed dairy-beef cross prepubertal heifers.

Across the trial as a whole, weight gain when feeding the experimental diet was 15% higher, and 20% higher in the second month, than when feeding the control diet. Both groups were allowed the same amount of forage daily, and both control and experimental diets were fully consumed within 24 hours of being fed.

It was noticeable that experimentally fed-animals showed better affect than controls, presumably due to better Mg nutrition and therefore reduced excitability but it is unlikely that this was a significant contributor to the improvement in weight gain.

### EXAMPLE 5

In a third trial, 50 Aberdeen angus steers were feed the preparation described below as a supplement to their normal diet of mixed hay and winter grazing, for a period of three months prior to slaughter.

Despite a period of extremely cold weather during the trial, the average daily weight gain for the group of animals was 1.86 kg, compared to 1.5 kg for animals conventionally grazed under the same conditions. The carcass quality was judged to be exceptional at slaughter.

The supplement (Supplement-Ca′) was prepared by reacting Pinot Noir marc with calcium carbonate and allowing the mixed components to stand for about six weeks at approximately 8° C., to allow chelation of the C₃/C₄ acids by the calcium cation.

The same preparation technique was used for a Riesling pomace, which also produced an acceptable supplement.

Further Dairy Trials

### EXAMPLE 6

On-Farm Evaluation in North-West England

A commercial evaluation was carried out in the Carlisle area of Northwest England during the early summer of 2018. This period coincided with the most extensive drought suffered in Cumbria since 1976: rainfall during this period was 33% of normal, and mean daily temperature was 2° C. higher than average.

The consequence of these conditions was to reduce pasture quality to that found under similar conditions in Canterbury, New Zealand—forage apparent metabolisable energy was reduced by 2 MJ/kg relative to the same time in the previous year. Despite this, addition of Supplement-Mg to cow diets prevented the expected loss of production. Across two farms, production was 11% higher than expected.

The supplement-Mg was prepared from CDS reacted with Magnesium Oxide and then dried while being mixed with wet cake. The proportion of lactic acid was measured and if necessary further lactic acid was added to standardise the lactic acid content of the CDS to 25%.

### EXAMPLE 7

On-Farm Evaluation in Western Waikato, New Zealand

Supplement-Mg prepared as in Example 6 was introduced in November 2018 into the diet of an extensively grazed commercial dairy herd located in a drought-prone area in the western Waikato in the North Island of New Zealand. Climatic conditions were similar to those experienced at the same time in the previous year, and herd age composition was similar.

At the time the product was introduced, a commercial anti-protozoal pharmaceutical was withdrawn from the animals' diet, but milk solids yield still rose by 6% relative to the previous year. Despite the withdrawal of the anti-protozoal compound, generally believed to provide an advantage in protein utilisation efficiency, milk urea concentration rose from 40 mmoles/L to >80 mmoles/L. At this point, a protein-rich supplement (2 kg/day of palm kernel expeller cake, providing approximately 400 g/day of crude protein) was withdrawn from the diet. Milk urea concentration fell to 30 mmoles/L, with no apparent effect on daily milk protein yield or total milk solids production.

The daily dose of Supplement-Mg provides approximately 80 g of by-pass protein leading to a nett reduction in dietary crude protein provision of 320 g.

Summary

Results presented above confirm that Supplement-Mg and Supplement-Ca support a substantial increase in feed utilisation efficiency not seen in any other product of this nature.

Protein Utilisation Efficiency

Ruminants are able to use dietary nitrogen sources of very low grade (e.g. chicken litter), as the great majority of their protein requirement is met by microbial protein. That is, the rumen microflora convert poor sources of dietary nitrogen into protein of moderately high quality, provided the nitrogen source is made accessible during fermentation. In practice, forage protein is only partially accessible during fermentation, as it is often encapsulated in fibrous material that is challenging for rumen flora to degrade. Supplement-Mg and Supplement-Ca aid flora to better degrade such material, as indicated by the markedly greater efficiency with which dietary protein is made available to the animal.

This increase in efficiency is shown by results from several investigations. The most revealing is the Western Waikato on-farm study, where dietary crude protein was reduced by 15% (reduction of 400 g of supplement protein, counterbalanced by addition of ˜80 g of bypass, high quality wheat protein in Supplement-Mg), without reduction in milk protein secretion or weight gain. The inference is that the reduction of protein intake leads to a reduction of N excretion of >50 g/cow/day, or >100 g/cow/day of NOₓ. The ratio of N loss to atmosphere vs loss to groundwater remains to be determined, but minimisation of contributions to either sink is known to be important for increased environmental integrity.

Other Results

### EXAMPLE 8

In a large commercial trial, (see Example 2) Supplement-Mg effects were compared with a control, and a 50:50 blend of the two supplements. Animals consuming Supplement-Mg prepared as in Example 2 produced milk containing 28.71 mM/L of urea, compared to 26.11 mM/L (+10.0%, p=0.09), with daily protein yield not significantly different. In a detailed trial in housed animals (preliminary data only) milk urea concentration was reduced in line with a reduction in feed intake, but with no reduction in daily milk protein secretion.

It has been observed that daily variation in milk protein secretion is considerably less than variation in milk fat secretion, suggesting that milk protein secretion is limited by the capacity of udder tissue to synthesise the specific proteins that constitute the nitrogenous component of milk solids, but that milk fat secretion is limited only by availability of serum fatty acids for its synthesis. Hence, it is not altogether surprising that there seems to be an opportunity for reduction in dietary crude protein concentration using Supplement-Mg, as better release of encapsulated plant crude protein enables rumen flora to produce more protein of high biological value for the use of the animal.

Biological value is a measure of the relative level of essential amino acids in proteins under comparison, and therefore the level of de novo protein synthesis possible. If all requirements for new protein production are satisfied (reflecting any limitations on tissue synthetic capacity) any residual amino acids are degraded in the liver, where excess amino residues are converted to urea for excretion in urine, raising serum urea concentration, and thus milk urea level.

By reducing diet crude protein level, and monitoring both milk urea and daily milk protein production, it is possible to optimise values of these parameters to minimise nitrogen excretion with the least impact on production, whether milk solids yield or liveweight gain.

Enhanced Immune Function

Immune function is known to be affected by metabolic energy balance, with nett energy loss being accompanied by poorer immune system performance.

This relationship has been the focus of many attempts to improve cow nutritional performance in the last month before calving, and in the period after calving, as milk production increases.

In the dairy cow, a common disorder is mastitis—an inflammation of the udder that is caused by any one of a number of infectious organisms, in conjunction with such insults as excessive milking action. It is accompanied by a substantial rise in the level of “somatic cells” (different classes of white blood cells) in milk. While at the onset of a particular infection, SCC (somatic cell count) concentration can rise to >10⁶; if the immune system is effective in dealing with the infection, SCC rapidly falls back to baseline.

The New Zealand Veterinary Association has estimated the cost of clearing up a “simple” case of mastitis to be $220, taking into account time, pharmaceuticals and lost production. Repeated infections in a single animal will lead to that animal being culled, with consequent loss of production for the balance of her lactation, and a cost of approximately $3000 to replace her, including production loss during the replacement's first lactation.

Clearly, there is considerable incentive to find lower cost mechanisms to avoid mastitis incidence.

Observations

In the first trial conducted in Southland, New Zealand (Example 1), it was observed that while individual animals on the experimental diet on the sampling subset had, on average, higher levels of somatic cell count (SSC), the incidence of mastitis in the experimentally fed animals was lower overall, and there were no cases of refractory mastitis (mastitis recurring in a single animal on several occasions).

In the second trial (Example 2), animals in the subset consuming the experimental diet enjoyed to reduction of 60% in mean SCC.

In a current on-farm feeding observation, herd mean SSC is reduced by approximately 50%, and there is no incidence of mastitis.

Aetiology

Mastitis refers to the collection of symptoms related to a disorder of the secretory tissue in the mammary gland. There are great many microbial organisms implicated in mastitis, but the most common ones in New Zealand are Staphylococcus aureus and Escherichia coli. Interestingly, one manifestation of Mycoplasma bovis is presentation of a refractory form of mastitis. This is due to the absence of any effective pharmacological intervention for mastitis caused by this organism, and the efficiency with which the aggravating organism hides from the animal's immune system.

Infection with bacterial forms of mastitis-causing organisms is accompanied by the full range of symptoms—inflammation, redness, pain and secretion of plasma and pus from infected tissues. If left untreated, in cows with impaired immune systems, the infection can progress to tissue death, gangrene, septicaemia and death of the animal.

Farmers often rely on elevated SSC as a symptom or predictor of the presence or likely onset of mastitis. SSC is a measure of the concentration of white blood cells in milk. White blood cells are summoned in the circulation to sites of infection once the inflammatory symptoms appear, but may also clear infectious organisms from tissues prior to a specific infection commencing. It is not clear which of the 20 or so classes of white blood cells are responsible for non-specific immunity (management of environmental populations of infectious organisms) and which are responsible for dealing with specific infection processes. The balance of the two classes of white blood cells will change with time if, for instance, despite the efforts of non-specific immune cells, an infection establishes. Clearly, once infection has taken hold the immune system attempts to swamp the tissue with appropriate classes of white blood cell, and at that time, SSC can increase 10 to 100-fold. If the immune response is successful, SSC will fall almost as rapidly, with specific cells involved in forming pus.

If a whole herd is monitored, SCC level is an indicator of general immune competence. In the large commercial trial described above (Example 2), long-term Supplement-Mg intake was accompanied by a significant reduction in log SCC (4.804 vs 5.186, p<0.001). Note that the data were transformed to a log scale before analysis, as there was enormous variation between individual measures. This is due to the fact that there are in fact two classes of white blood cells involved in immune system management of mastitis: a basal level contributing non-specific immunity, and a second class that respond specifically to the particular causative organism. This second class, in response to an infection, may be released into the udder at 10-100 times the level of the white blood cells conferring generalised immunity. Therefore, if even a few infections are present in a herd at the time of sampling, overall SCC can behave rather confusingly.

In a separate commercial evaluation, no mastitis infections have been observed, in response to feed Supplement-Mg, whereas 18% of the same herd suffered infection through lactation in the 2018-19 season. SCC is approximately 40% lower that for the same period twelve months ago. Provision of Supplement-Mg is the only change, apart from a limited reduction in dietary crude protein level, and this is not known to aid mastitis prevention.

It is not clear why the method of the present invention leads to a reduction in the incidence of mastitis. One possible explanation is that the improved nutrition, and in particular the enhanced metabolic energy balance, provided by the method of the present invention leads to enhanced immune competence which naturally increases the resistance to infection such as mastitis. Another possible explanation is that it is known that particular classes of non-starch polysaccharides are involved in the stimulation of differentiation of immature white blood cells and this could result in a reduction in the number of infections actually initiating in the animal.

Nitrogen Excretion

### EXAMPLE 9

Supplement-Mg prepared as in Example 6 was fed to a lactating spring-calving dairy herd of approximately 500 cows whose principal diet was grazed pasture at a rate of 16 kg of dry matter/cow/day, and palm kernel expeller cake (PK) at 2 kg/head/day. At the commencement of feeding, average milk urea content was 40 mg/L. As Supplement-Mg consumption continued, milk urea content rose to 80 mg/L, with no increase in herd milk protein secretion. The PK was removed from the diet, but no increase in pasture drymatter allowance was made. Milk urea level fell to ˜30 mg/L, but milk protein secretion was not affected. The inference to be drawn was that Supplement-Mg was increasing the ability of the rumen flora to release dietary crude protein in a form able to be used by the animal, and by enabling conversion of this crude protein to microbial protein, improved the match between dietary amino acid composition and animal needs, meaning that less was wasted. Although the nett reduction in dietary protein intake was 15%, it is estimated that nitrogen excretion was reduced by 50%.

1. A method of supplementing the diet of a ruminant animal to improve one or more of the features selected from the group consisting of:
ruminal efficiency;
elevation of rumen pH and depression of faecal pH;
weight gain;
feed utilisation;
utilisation of dietary protein;
reduction in nitrogen excretion;
immune function;
wherein for a period of at least 10 days the animal is fed a prebiotic supplement in a quantity equivalent to at least 2% of the total daily dry matter intake for that animal;
and wherein the supplement includes a chelate of a C₃/C₄ organic acid, microbial components and non-starch polysaccharides;
and wherein the supplement is prepared by reacting a prepared precursor which contains C₃/C₄ organic acids with a multivalent cation source to precipitate a reaction product;
and wherein the prepared precursor is prepared from a starting material selected from the group consisting of:
an un-dried fermentation or distillation byproduct;
an un-dried fermentation or distillation product;
un-dried acidic plant material;
un-dried pomace;
whey.

2. The method as claimed in claim 1 wherein the C₃/C₄ organic acid is lactic acid.

3. The method as claimed in claim 1 wherein the multivalent cation source is selected from one or more of the group consisting of: magnesium compounds, calcium compounds, iron compounds, copper compounds, cobalt compounds, manganese compounds, zinc compounds, molybdenum compounds.

4. The method as claimed in claim 1 wherein the multivalent cation source is one or more natural minerals.

5. The method as claimed in claim 4 wherein the natural mineral is selected from one or more of the group consisting of: limestone, dolomite, magnesite.

6. The method as claimed in claim 3 wherein the multivalent cation source is selected from one or more of the group consisting of: oxides, carbonates, hydroxides, chlorides, sulphates, nitrates, phosphates.

7. The method as claimed in claim 1 wherein the microbial components are selected from the group consisting of: yeasts, lactobacillus species, bifidobacter species.

8. The method as claimed in claim 1 wherein the reaction between the prepared precursor and the multivalent cation source is carried out at a temperature below the Maillard threshold temperature.

9. The method as claimed in claim 1 wherein the starting material for the prepared precursor is a pomace, and the pomace is fermented before reacting with the multivalent cation source.

10. The method as claimed in claim 1 wherein the prepared precursor contains 20%-30% organic acids, no more than 10% of which is acetic acid.

11. The method as claimed in claim 1 wherein the starting material for the prepared precursor is an acidic plant material and wherein said plant material has a pH less than 5.

12. The method as claimed in claim 1 wherein the precursor contains 5%-15 glycerol, 5%-50% protein, and 5%-50% non-starch polysaccharides.

13. The method as claimed in claim 12 wherein a majority of the non-starch polysaccharides are selected from the group consisting of one or more of: arabinoxylans, beta-glucans of cereal origin, pectins of plant cell wall origin, yeast cell wall components.

14. The method as claimed in claim 1 wherein the supplement has a pH in the range 6.3-7.2.

15. The method as claimed in claim 1 wherein the multivalent cation source consists of or includes a magnesium compound, such that the supplement includes a magnesium lactate chelate.

16. The method as claimed in claim 15 wherein the supplement is fed to cattle and the ruminal efficiency is improved such that the protein levels of the diet fed to the cattle can be reduced by 15%-20% without any reduction in the amount of protein available to each animal.

17. The method as claimed in claim 16 wherein there is a reduction of up to 50% in nitrogen excreted by each animal.

18. The method as claimed in claim 16 wherein the incidence of infections in the cattle is significantly reduced.

19. The method as claimed in claim 1 wherein the supplement is fed in a quantity equivalent to between 2% and 5% of the total daily dry matter intake for each animal.

20. A method of supplementing the diet of a ruminant animal to improve one or more of the features selected from the group consisting of:
ruminal efficiency;
elevation of rumen pH and depression of faecal pH;
weight gain;
feed utilisation;
utilisation of dietary protein;
reduction in nitrogen excretion;
immune function;
wherein for a period of at least 10 days the animal is fed a prebiotic supplement in a quantity equivalent to at least 2% of the total daily dry matter intake for that animal;
and wherein the supplement includes a chelate of a C₃/C₄ organic acid, microbial components, and non-starch polysaccharides;
and wherein the supplement is prepared by reacting condensed distillers solubles with magnesium oxide to precipitate a reaction product.

21. The method as claimed in claim 20 wherein the C₃/C₄ organic acid is lactic acid.

22. The method as claimed in claim 20 wherein, after the condensed distillers solubles and magnesium oxide have been reacted together, the product of the reaction is fed onto wet cake during a drying process.

23. A method of supplementing the diet of a ruminant animal to improve one or more of the features selected from the group consisting of:
ruminal efficiency;
elevation of rumen pH and depression of faecal pH;
weight gain;
feed utilisation;
utilisation of dietary protein;
reduction in nitrogen excretion;
immune function;
wherein for a period of at least 10 days the animal is fed a prebiotic supplement in a quantity equivalent to at least 2% of the total daily dry matter intake for that animal;
and wherein the supplement includes a chelate of a C₃/C₄ organic acid, microbial components, and non-starch polysaccharides;
and wherein the supplement is prepared by reacting grape marc with calcium carbonate to precipitate a reaction product.

24. The method as claimed in claim 23 wherein the C₃/C₄ organic acid is lactic acid.

25. The method as claimed in claim 1 wherein the ruminant animal is a cattle beast.

26. The method as claimed in claim 20 wherein the ruminant animal is a cattle beast.

27. The method as claimed in claim 23 wherein the ruminant animal is a cattle beast.
